(19) United States
(12) Patent Application Publication
(10) Pub. No.: US 2024/0292439 A1
(43) Pub. Date: Aug. 29, 2024

(54) TRANSMISSION PROCESSING METHOD AND APPARATUS, TERMINAL, AND READABLE STORAGE MEDIUM

(71) Applicant: VIVO MOBILE COMMUNICATION CO., LTD., Guangdong (CN)

(72) Inventors: Siqi LIU, Guangdong (CN); Zichao JI, Guangdong (CN)

(73) Assignee: VIVO MOBILE COMMUNICATION CO., LTD., Guangdong (CN)

(21) Appl. No.: 18/649,408

(22) Filed: Apr. 29, 2024

Related U.S. Application Data
(63) Continuation of application No. PCT/CN2022/128016, filed on Oct. 27, 2022.

(30) Foreign Application Priority Data
Nov. 1, 2021 (CN) 202111284015.1

(51) Int. Cl. H04W 72/40; H04L 5/00; H04W 72/02; H04W 72/0446; H04W 92/18

(52) U.S. Cl. CPC H04W 72/40; H04L 5/0048; H04W 72/02; H04W 72/0446; H04W 92/18

(57) ABSTRACT

A transmission processing method and apparatus, a terminal, and a readable storage medium. The transmission processing method in embodiments of this application includes: determining, by a terminal, N resource objects used for a first signal, where the first signal includes at least one of a synchronization signal block and a preset signal, where N is a positive integer, the N resource objects are located within L target time objects, L is a positive integer, the target time object includes a period, a timer, a time window, a transmission cluster, a preset time period, a channel occupancy time, or a time domain unit, and the resource object is a candidate resource or a candidate resource group.

### CROSS-REFERENCE TO RELATED APPLICATIONS

This application is a continuation of International Application No. PCT/CN2022/128016 filed on Oct. 27, 2022, which claims priority to Chinese Patent Application No. 202111284015.1 filed on Nov. 1, 2021, which are incorporated herein by reference in their entireties.

### TECHNICAL FIELD

This application pertains to the field of communications technologies, and particularly relates to a transmission processing method and apparatus, a terminal, and a readable storage medium.

### BACKGROUND

To obtain more resources to meet service requirements in sidelink (SL) transmission, it is discussed that SL transmission may be required in an unlicensed or shared band. Due to possible presence of other wireless technologies in the unlicensed band, a terminal needs to monitor whether a resource is idle and attempt to initiate channel access and transmission after determining that the resource is idle. Therefore, how to set candidate resources and implement sidelink transmission in the unlicensed band has become an urgent problem to be resolved.

### SUMMARY

Embodiments of this application provide a transmission processing method and apparatus, a terminal, and a readable storage medium.

According to a first aspect, a transmission processing method is provided and includes:
determining, by a terminal, N resource objects used for a first signal, where the first signal includes at least one of a synchronization signal block and a preset signal, where
N is a positive integer, the N resource objects are located within L target time objects, L is a positive integer, the target time object includes a period, a timer, a time window, a transmission cluster, a preset time period, a channel occupancy time, or a time domain unit, and the resource object is a candidate resource or a candidate resource group.

According to a second aspect, a transmission processing apparatus is provided and includes:
a determining module, configured to determine N resource objects used for a first signal, where the first signal includes at least one of a synchronization signal block and a preset signal, where
N is a positive integer, the N resource objects are located within L target time objects, L is a positive integer, the target time object includes a period, a timer, a time window, a transmission cluster, a preset time period, a channel occupancy time, or a time domain unit, and the resource object is a candidate resource or a candidate resource group.

According to a third aspect, a terminal is provided. The terminal includes a processor, a memory, and a program or instructions stored in the memory and capable of running on the processor. When the program or instructions are executed by the processor, the steps of the method according to the first aspect are implemented.

According to a fourth aspect, a terminal is provided and includes a processor and a communication interface, where
the processor is configured to determine N resource objects used for a first signal, where the first signal includes at least one of a synchronization signal block and a preset signal, where
N is a positive integer, the N resource objects are located within L target time objects, L is a positive integer, the target time object includes a period, a timer, a time window, a transmission cluster, a preset time period, a channel occupancy time, or a time domain unit, and the resource object is a candidate resource or a candidate resource group.

According to a fifth aspect, a readable storage medium is provided. The readable storage medium stores a program or instructions. When the program or instructions are executed by a processor, the steps of the method according to the first aspect are implemented.

According to a sixth aspect, an embodiment of this application provides a chip. The chip includes a processor and a communication interface. The communication interface is coupled to the processor. The processor is configured to run a program or instructions to implement the steps of the method according to the first aspect.

According to a seventh aspect, a computer program product is provided. The computer program product is stored in a non-transitory storage medium. The computer program product is executed by at least one processor to implement the method according to the first aspect.

According to an eighth aspect, a communication device is provided. The communication device is configured to perform the steps of the method according to the first aspect.

### BRIEF DESCRIPTION OF DRAWINGS

FIG. 1 is a structural diagram of a wireless communications system to which an embodiment of this application can be applied;

FIG. 2 is a flowchart of a transmission processing method according to an embodiment of this application;

FIG. 3 to FIG. 16 are exemplary diagrams of transmission in a transmission processing method according to an embodiment of this application;

FIG. 17 is a structural diagram of a transmission processing apparatus according to an embodiment of this application;

FIG. 18 is a structural diagram of a communication device according to an embodiment of this application; and

FIG. 19 is a structural diagram of a terminal according to an embodiment of this application.

### DETAILED DESCRIPTION

The following clearly describes the technical solutions in the embodiments of this application with reference to the accompanying drawings in the embodiments of this application. Apparently, the described embodiments are only some rather than all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specified order or sequence. It should be understood that the terms used in this way are interchangeable in appropriate circumstances, so that the embodiments of this application can be implemented in other orders than the order illustrated or described herein. In addition, objects distinguished by “first” and “second” usually fall within one class, and a quantity of objects is not limited. For example, there may be one or more first objects. In addition, the term “and/or” in the specification and claims indicates at least one of connected objects, and the character “/” generally represents an “or” relationship between associated objects.

It should be noted that technologies described in the embodiments of this application are not limited to a long term evolution (LTE)/LTE-Advanced (LTE-A) system, and can also be used in other wireless communications systems, such as code division multiple access (CDMA), time division multiple access (TDMA), frequency division multiple access (FDMA), orthogonal frequency division multiple access (OFDMA), single-carrier frequency-division multiple access (SC-FDMA), and other systems. The terms “system” and “network” in the embodiments of this application are usually used interchangeably. The described technologies may be used for the foregoing systems and radio technologies, and may also be used for other systems and radio technologies. In the following descriptions, a new radio (NR) system is described for an illustrative purpose, and NR terms are used in most of the following descriptions. However, these technologies may also be applied to other applications than an NR system application, for example, a 6th Generation (6G) communications system.

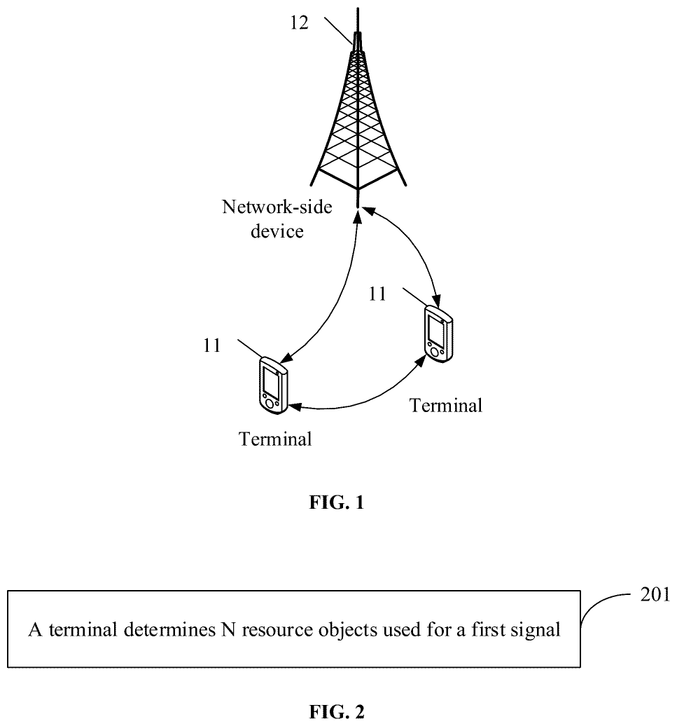

FIG. 1 is a block diagram of a wireless communications system to which an embodiment of this application may be applied. The wireless communications system includes a terminal 11 and a network-side device 12. The terminal 11 may be a terminal-side device such as a mobile phone, a tablet personal computer, a laptop computer or a notebook computer, a personal digital assistant (PDA), a palmtop computer, a netbook, an ultra-mobile personal computer (UMPC), a mobile Internet device (MID), an augmented reality (AR) or virtual reality (VR) device, a robot, a wearable device, vehicle user equipment (VUE), pedestrian user equipment (PUE), or a smart home (a home device having a wireless communication function, such as a refrigerator, a television, a washing machine, or furniture). The wearable device includes a smartwatch, a smart band, a smart headphone, smart glasses, smart jewelry (a smart bracelet, a smart wrist chain, a smart ring, a smart necklace, a smart anklet, a smart ankle chain, or the like), a smart wristband, smart clothing, a game console, or the like. It should be noted that a specific type of the terminal 11 is not limited in the embodiments of this application. The network-side device 12 may be a base station or a core network device. The base station may be referred to as an access point, a base transceiver station (BTS), a radio base station, a radio transceiver, a basic service set (BSS), an extended service set (ESS), a NodeB, an evolved NodeB (eNB), a home NodeB, a home evolved NodeB, a wireless local area network (WLAN) access point, a Wi-Fi node, a transmission and reception point (TRP), or another appropriate term in the art, as long as the same technical effect is achieved. The base station is not limited to specific technical terms. It should be noted that in the embodiments of this application, only a base station in an NR system is used as an example, but a specific type of the base station is not limited.

For ease of understanding, the following describes some content in the embodiments of this application.

In a future communications system, a shared spectrum such as an unlicensed band may be used to supplement a licensed band, to help an operator expand services. To keep consistency with NR deployment and maximize NR-based unlicensed access as much as possible, the unlicensed band can work in 5 GHz, 37 GHz, and 60 GHz bands. Because the unlicensed band is shared by a plurality of radio access technologies (RATs), such as Wi-Fi, radar, and LTE licensed-assisted access (LTE-LAA), in some countries or regions, use of the unlicensed band needs to comply with regulations, such as listen before talk (LBT), a maximum channel occupancy time (MCOT), and other regulations, to ensure that all devices can use the resource fairly. When a transmission node needs to send information, the transmission node needs to perform LBT first and perform energy detection (ED) on nearby nodes. When detected power is lower than a threshold, a channel is considered as idle and the transmission node can send the information. Otherwise, the channel is considered as busy and the transmission node cannot send the information. The transmission node may be a base station, UE, a Wi-Fi access point (AP), or the like. After the transmission node starts transmission, a channel occupancy time COT cannot exceed the MCOT.

Commonly used LBT categories may be classified into category 1, category 2, and category 4.

Category 1 LBT means that a sending node does not perform LBT, that is, there is no LBT or immediate transmission is performed.

Category 2 LBT is one-shot LBT, that is, the node performs LBT once before transmission. If the channel is idle, the node performs transmission, or if the channel is busy, the node does not perform transmission.

Category 4 LBT is a channel listening mechanism based on back-off. When the transmission node detects that the channel is busy, the transmission node backs off and continues listening until the transmission node detects that the channel is idle.

For a base station, category 2 LBT is applied to a physical downlink shared channel (PDSCH) without a demodulation reference signal (DMRS), and category 4 LBT is applied to a PDSCH, a physical downlink control channel (PDCCH), or an enhanced physical downlink control channel (ePDCCH).

For a terminal, category 4 LBT corresponds to a type 1 uplink channel access procedure (type 1 UL channel access procedure), and category 2 LBT corresponds to a type 2 uplink channel access procedure (type 2 UL channel access procedure).

Equipment that performs LBT includes frame based equipment (FBE) and load based equipment (LBE).

The FBE means that a period structure is used for transmission/reception timing of the equipment, and the period is a fixed frame period (FFP). An FBE node uses an LBT-based channel access mechanism to occupy the channel. A node that initiates a transmission sequence including one or more continuous transmissions is referred to as an initiating node (Initiating Device), and other nodes are referred to as responding nodes (Responding Device). The FBE node may be an initiating node, or a responding node, or support functions of both nodes.

For the LBE, the transmission node may start LBT at any time and can perform transmission only after the transmission node detects that the channel is idle. For the transmission node, there is no fixed listening time, and there is no need to skip when the transmission node detects that the channel is busy. The transmission node can continue listening by backing off several extended clear channel assessments (CCA) until an eCCA counter reaches zero.

A transmission processing method provided in the embodiments of this application is hereinafter described in detail by using some embodiments and application scenarios thereof with reference to the accompanying drawings.

FIG. 2 is a flowchart of a transmission processing method according to an embodiment of this application. As shown in FIG. 2, the method includes the following step.

Step 201: A terminal determines N resource objects used for a first signal, where the first signal includes at least one of a synchronization signal block and a preset signal, where
N is a positive integer, the N resource objects are located within L target time objects, L is a positive integer, the target time object includes a period, a timer, a time window, a transmission cluster, a preset time period, a channel occupancy time, or a time domain unit, and the resource object is a candidate resource or a candidate resource group.

In this embodiment of this application, both the candidate resource and the candidate resource group are candidate resources of an unlicensed band or a shared band. One candidate resource group may include one or more candidate resources. When a candidate resource group includes one candidate resource, there is no concept of the candidate resource group, that is, the candidate resource group may be replaced with the candidate resource.

Optionally, in some embodiments, a candidate resource group may include N1 first candidate resources and N2 second candidate resources, where N1 and N2 are both natural numbers, and a sum of N1 and N2 is greater than 0. The first candidate resource is used for a synchronization signal block, and the second candidate resource is used for a preset signal.

Optionally, a resource object used for a first signal may be understood as a resource object that can be used for transmitting or detecting or monitoring the first signal.

It should be understood that in this embodiment of this application, the N resource objects can be configured or preconfigured for the terminal based on units of target time objects, so that the terminal determines the resource object used for the first signal. The timer included in the target time object may be understood as running duration of the timer of the target time object. The time domain unit may be a slot, a mini slot, a frame, a subframe, a millisecond (ms), a symbol, or a span. The preset time may be a period or duration, for example, may be a frame period. The transmission cluster may be understood as a group, a cluster, a set, or a burst.

It should be noted that when a target time object includes a plurality of candidate resources, transmission opportunities can be increased, so that transmission reliability is improved.

In this embodiment of this application, the terminal determines N resource objects used for a first signal, where the first signal includes at least one of a synchronization signal block and a preset signal, where N is a positive integer, the N resource objects are located within L target time objects, L is a positive integer, the target time object includes a period, a timer, a time window, a transmission cluster, a preset time period, a channel occupancy time, or a time domain unit, and the resource object is a candidate resource or a candidate resource group. Because it is clear that the N resource objects are determined based on units of target time objects, after LBT succeeds, the terminal transmits, detects, or monitors the first signal based on the N resource objects. Therefore, in this embodiment of this application, sidelink transmission can be implemented in the unlicensed band, and further, flexibility of communication is effectively improved.

Optionally, in some embodiments, the N resource objects meet at least one of the following:
M1 resource objects among the N resource objects are continuous in time domain;
a time domain interval between M2 resource objects among the N resource objects is less than or equal to a first preset value;
a first interval before or after at least part of M3 resource objects is less than or equal to the first preset value, where the M3 resource objects are at least part of the N resource objects;
M4 first signals associated with at least part of the N resource objects are continuous;
a time domain interval between M5 first signals associated with at least part of the N resource objects is less than or equal to the first preset value; and
a second interval before or after at least part of M6 first signals is less than or equal to the first preset value, where the M6 first signals are first signals associated with at least part of the N resource objects, where
all of M1, M2, M3, M4, M5, and M6 are positive integers.

In this embodiment of this application, meeting at least one of the foregoing may be referred to as meeting a first condition. That the N resource objects meet the first condition can be ensured by a configuration, specified in a protocol, preconfigured, assumed by the terminal, or ensured by the terminal. In this way, there are more transmission opportunities after successful access, and transmission reliability is ensured. Optionally, in some embodiments, value ranges of the time domain interval between the M2 resource objects, the first interval, the time domain interval between the M5 first signals, and the second interval may be different, and thresholds thereof may also be different.

It should be understood that continuity of the M1 resource objects in time domain may be understood as “there is no time domain interval between the M1 resource objects, or the time domain interval is 0”. It may also be understood that there is no first interval before or after the M1 resource objects, or that the first interval is 0. In this embodiment of this application, the time domain interval between the M2 resource objects, the time domain interval between the M5 first signals, the first interval, and the second interval may be understood as “no transmission, listening, or detection is performed on the time domain resources and/or symbols”.

It should be noted that in this embodiment of this application, each interval may be understood as a guard period (GP). A signal may be referred to as a channel. For example, the preset signal may be referred to as a preset channel. In addition, transmission in this embodiment of this application may be understood as sending or receiving.

Optionally, in some embodiments, first signals associated with the N resource objects meet at least one of the following:
at least part of first signals do not include a third interval;
target time objects in which at least part of first signals are located do not include a fourth interval;
at least part of first signals include a fifth interval, and the fifth interval is less than or equal to a first preset value; and
target time objects in which at least part of first signals are located include a sixth interval, and the sixth interval is less than or equal to the first preset value.

In this embodiment of this application, the third interval, the fourth interval, the fifth interval, and the sixth interval may be understood as time domain resources and/or symbols on which no transmission, listening, or detection is performed. In some embodiments, value ranges of the fifth interval and the sixth interval may be different, and thresholds thereof may also be different. Because the first signals associated with the N resource objects are set to meet at least one of the foregoing, the terminal can have more transmission opportunities after successful access, thereby ensuring coverage of the first signals. Therefore, transmission reliability can be improved.

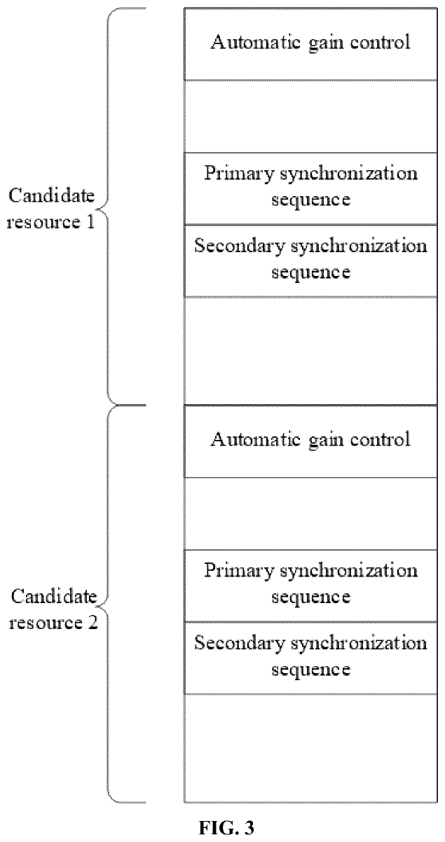

As shown in FIG. 3, a synchronization signal block is used as an example for description. In FIG. 3, two continuous synchronization signal blocks (for example, a synchronization signal block 1 and a synchronization signal block 2) are included, where the synchronization signal block 1 does not include a GP, and the synchronization signal block 2 may have an interval or GP. A primary synchronization sequence (PSS) shown in FIG. 3 does not mean that there is only one PSS symbol, but there may be one or more PSS symbols. A secondary synchronization sequence (SSS) means that there may be one or more SSS symbols. An automatic gain control (AGC) symbol may be a physical sidelink broadcast channel (PSBCH). In addition, an arrangement order of the symbols is not limited to that shown in FIG. 3. For example, in some embodiments, the SSS may precede the PSS, or the PSS and the SSS are discontinuous.

Optionally, in some embodiments, there may be an interval for a last first signal, or there may be an interval for a last target time object. For example, the at least part of first signals meet at least one of the following:
the at least part of first signals are first N1−1 first signals, where N1 is the total number of the first signals associated with the N resource objects; and
the target time objects in which the at least part of first signals are located include first L−1 target time objects among the L target time objects.

It should be understood that the first preset value may be set based on an actual requirement. For example, in some embodiments, the first preset value is a product of a first threshold and 25 μs, 16 μs, 9 μs, 4 μs, listening duration corresponding to the first signal, listening duration corresponding to the resource object, listening duration corresponding to the target time object, duration required for category 2 listening, duration required for category 4 listening, or duration required for category 1 listening. Preferably, the first threshold is 1.

In some embodiments, a value of N1 may be N.

Listening in this embodiment of this application may be understood as LBT. In this case, the category 2 listening may be referred to as Cat2 LBT, the category 1 listening may be referred to as Cat1 LBT, and the category 4 listening may be referred to as Cat4 LBT.

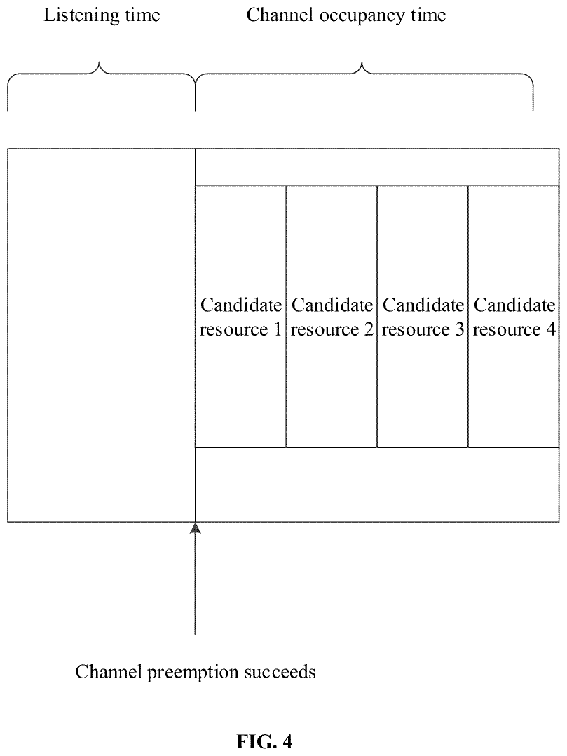

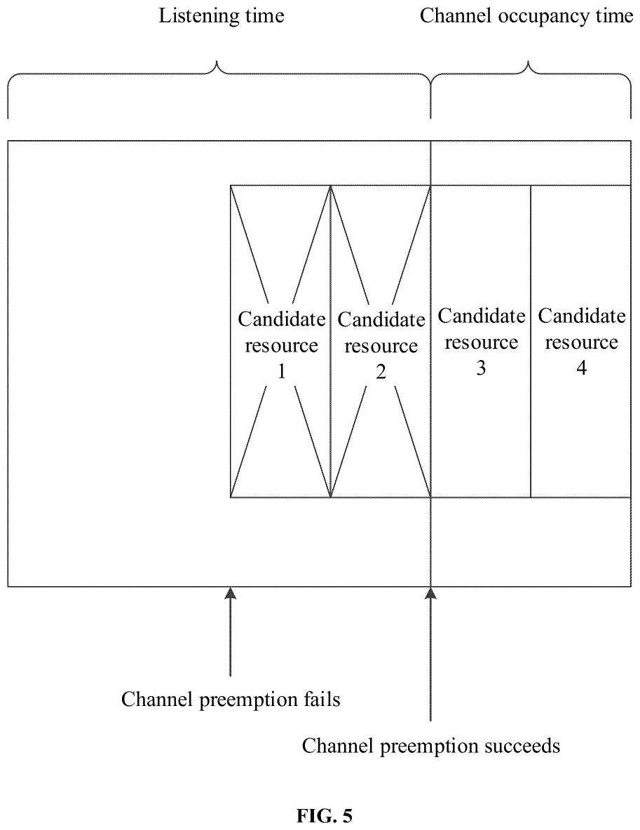

Optionally, after the LBT succeeds, because a plurality of resource objects are used to transmit the first signals, coverage of the first signals can be ensured, and transmission reliability can be improved. For example, as shown in FIG. 4 and FIG. 5, assuming that there are four candidate resources, where the four candidate resources are continuous, and that channel preemption succeeds at a time n through LBT, as shown in FIG. 4, before a transmission start time of a candidate resource 1, if LBT succeeds, at least one of a synchronization signal block corresponding to the candidate resource 1, a synchronization signal block corresponding to a candidate resource 2, a synchronization signal block corresponding to a candidate resource 3, and a synchronization signal block corresponding to a candidate resource 4 can be transmitted. As shown in FIG. 5, when the terminal succeeds in LBT before a transmission start time of the candidate resource 3, the terminal can transmit at least one of the synchronization signal block corresponding to the candidate resource 3 and the synchronization signal block corresponding to the candidate resource 4.

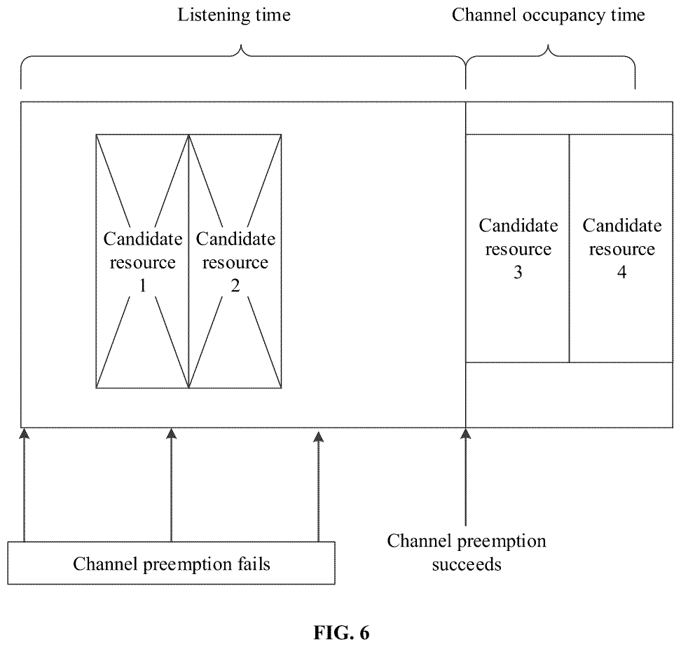

As shown in FIG. 6, in some embodiments, among the four candidate resources, it is also possible to set the first two candidate resources to be continuous, the next two candidate resources to be continuous, and the first two candidate resources to be discontinuous from the last two candidate resources. When the terminal succeeds in LBT before the transmission start time of the candidate resource 3, the terminal can transmit at least one of the synchronization signal block corresponding to the candidate resource 3 and the synchronization signal block corresponding to the candidate resource 4.

Optionally, in some embodiments, the N resource objects meet any one of the following:
a time domain interval between M7 resource objects among the N resource objects is greater than or equal to a second preset value;
a seventh interval exists before or after at least part of M8 resource objects, and the seventh interval is greater than or equal to the second preset value, where the M8 resource objects are at least part of the N resource objects;
a time domain interval between M9 first signals in the N resource objects is greater than or equal to the second preset value; and
an eighth interval exists before or after at least part of M10 first signals, and the eighth interval is greater than or equal to the second preset value, where the M10 first signals are first signals associated with at least part of the N resource objects, where all of M7, M8, M9, and M10 are positive integers.

In this embodiment of this application, meeting at least one of the foregoing may be referred to as meeting a second condition. That the N resource objects meet the second condition can be ensured by a configuration, specified in a protocol, preconfigured, assumed by the terminal, or ensured by the terminal. Because each of the foregoing intervals is greater than or equal to the second preset value, the terminal can perform listening at a corresponding interval, thereby constraining a listening behavior of the terminal, and further improving transmission reliability.

Optionally, the seventh interval and the eighth interval are used for listening.

Optionally, in some embodiments, first signals associated with the N resource objects meet at least one of the following:
at least part of first signals include a ninth interval, and the ninth interval is greater than or equal to a second preset value; and
target time objects in which at least part of first signals are located include a tenth interval, and the tenth interval is greater than or equal to the second preset value.

In this embodiment of this application, the tenth interval may be understood as an interval between a first signal and a start point, an end point, or a reference point of a target time object in which the first signal is located. For example, the synchronization signal block is located in a frame period of a frame structure, and an interval between the synchronization signal block and a start point of a first slot in the frame period is the second preset value.

Optionally, the second preset value may be set based on an actual requirement. For example, in some embodiments, the second preset value is a product of a second threshold and 25 μs, 16 μs, 9 μs, 4 μs, listening duration corresponding to the first signal, listening duration corresponding to the resource object, listening duration corresponding to the target time object, duration required for category 2 listening, duration required for category 4 listening, or duration required for category 1 listening. Preferably, the second threshold is 1.

Listening in this embodiment of this application may be understood as LBT.

It should be understood that in this embodiment of this application, because a listening time is reserved by using the foregoing interval, the terminal can start listening from the listening time. This specifies an opportunity to listen to attempt to send the first signal, and fixes an opportunity to attempt to detect the first signal, so that complexity of sending or detecting the first signal is reduced.

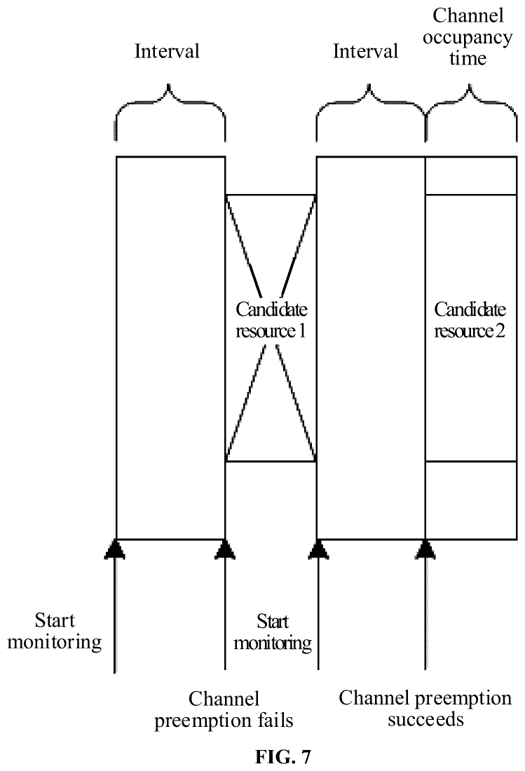

As shown in FIG. 7, a synchronization signal block is used as an example for description. In FIG. 7, it is assumed that there are two discontinuous candidate resources (a candidate resource 1 and a candidate resource 2). A guard period 1 exists before the candidate resource 1, and a guard period 2 exists between the candidate resource 1 and the candidate resource 2. The terminal starts LBT at a start point of each guard period. Assuming that LBT succeeds before the candidate resource 2, a synchronization signal block corresponding to the candidate resource 2 can be transmitted.

Optionally, in some embodiments, it is also possible to set part of the N resource objects to meet the first condition and part of the N resource objects to meet the second condition. For example, no interval or GP exists in part of synchronization signal blocks corresponding to the N resource objects, or an interval or GP exists, but the interval or GP is less than or equal to a preset threshold, that is, this part of synchronization signal blocks meet the first condition. An interval or GP exists in time domain units in which the part of synchronization signal blocks corresponding to the N resource objects are located, and the interval or GP is greater than a preset threshold, that is, this part of synchronization signal blocks meet the second condition.

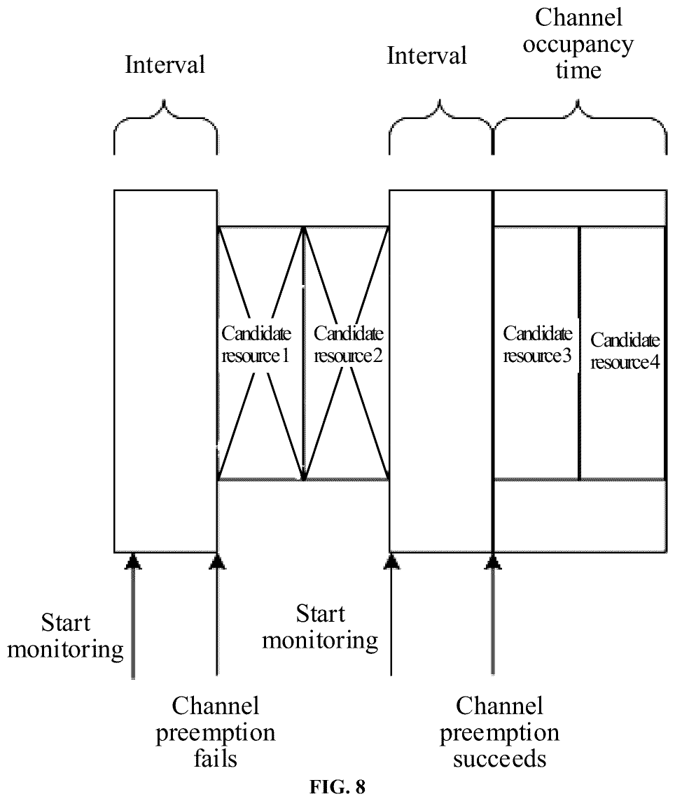

In some embodiments, synchronization signal blocks without intervals or with intervals less than or equal to a preset threshold are located in a same time domain unit. As shown in FIG. 8, there are two candidate clusters, that is, candidate resources corresponding to two transmission clusters, where first two continuous candidate resources (such as a candidate resource 1 and a candidate resource 2, that is, a candidate cluster 1) correspond to a transmission cluster, and next two continuous candidate resources (such as a candidate resource 3 and a candidate resource 4, that is, a candidate cluster 2) correspond to a transmission cluster. An interval for LBT exists before both the transmission cluster 1 and the transmission cluster 2. Assuming that LBT succeeds in an interval before the candidate resource 3, at least one of a synchronization signal block corresponding to the candidate resource 3 and a synchronization signal block corresponding to the candidate resource 4 can be transmitted.

It should be noted that when the resource object is a candidate resource group, the candidate resource group may be understood as a transmission cluster, and the transmission cluster can meet the second condition. Candidate resources in the transmission cluster can meet the first condition.

Optionally, a value of N may be set based on an actual requirement. For example, in some embodiments, the value of N is a fourth preset value or log₂ S, where S is a subcarrier spacing or a reference subcarrier spacing of a synchronization signal block. The fourth preset value may be 1, 2, 4, 8, 16, 24, 32, 64, or other values, which are not listed herein.

Optionally, in some embodiments, an interval exists between different target time objects. The interval may be configured, preconfigured, specified in a protocol, or determined by the terminal autonomously. For example, the interval may be determined based on at least one of a synchronization signal priority, a channel access priority, or a channel occupancy time.

Optionally, in some embodiments, target information is associated with at least one of the following: the number of listening success times, a listening success probability, the number of listening failure times, a listening failure probability, the number of times that a right to use a channel or carrier is obtained, the number of times that the channel or carrier is determined as idle, the number of times or a probability that a right to use the first signal is obtained, the number of times or a probability that the first signal is determined as idle, the number of times or a probability that a right to use the resource object is obtained, the number of times or a probability that the resource object is determined as idle, the number of times or a probability that the right to use the channel or carrier is not obtained, the number of times or a probability that the channel or carrier is determined as busy, the number of times or a probability that the right to use the first signal is not obtained, the number of times or a probability that the first signal is determined as busy, the number of times or a probability that the right to use the resource object is not obtained, the number of times or a probability that the resource object is determined as busy, channel conditions, a listening mode, a channel or carrier sharing mode, the number of beams, the number of the resource objects, a frequency domain position, a frequency domain range, and a subcarrier spacing (SCS), where
the target information includes at least one of the following: duration corresponding to the target time object, L, and M.

In this embodiment of this application, the target information may be determined based on at least one of a synchronization signal priority, a channel access priority, a channel occupancy time, or the like. The listening may be understood as LBT.

The duration corresponding to the target time object is associated with the number of LBT success times or the LBT success probability of the terminal. It may be understood that the duration corresponding to the target time object is associated with the number of LBT success times or the LBT success probability of the terminal within a time period. For example, it may be assumed that the duration is directly proportional to the number of success times or the success probability. For example, the greater the number of success times or the success probability, the longer the duration; or the smaller the number of success times or the success probability, the shorter the duration. For example, in some embodiments, when the number of success times or the success probability is equal to or exceeds the first threshold, the duration is a first value (for example, 160 ms); or when the number of success times or the success probability is equal to or less than the second threshold, the duration is a second value (for example, 20 ms). In addition, it may be assumed that the duration is inversely proportional to the number of success times or the success probability. For example, the greater the number of success times or the success probability, the shorter the duration; or the smaller the number of success times or the success probability, the longer the duration.

The duration corresponding to the target time object is associated with the number of LBT failure times or an LBT failure probability of the terminal. It may be understood that the duration corresponding to the target time object is associated with the number of LBT failure times or the LBT failure probability of the terminal within a time period. For example, it may be assumed that the duration is inversely proportional to the number of failure times or the failure probability. For example, the greater the number of failure times or the failure probability, the shorter the duration; or the smaller the number of failure times or the failure probability, the longer the duration. For example, in some embodiments, when the number of failure times or the failure probability is equal to or exceeds a third threshold, the duration is a third value (for example, 20 ms); or when the number of failure times or the failure probability is equal to or less than a fourth threshold, the duration is a fourth value (for example, 160 ms). In addition, it may be assumed that the duration is directly proportional to the number of failure times or the failure probability. For example, the greater the number of failure times or the failure probability, the longer the duration; or the smaller the number of failure times or the failure probability, the shorter the duration.

In some embodiments, the target time object may be associated with the number of times and/or a probability that the right to use the channel and/or carrier is obtained by the terminal within a time period, or the number of times and/or a probability that the channel and/or carrier are/is determined as idle or available, or the number of times and/or a probability that a right to use the synchronization signal block is obtained, or the number of times and/or a probability that a synchronization signal block candidate resource is determined as idle or available. For example, it may be assumed that the duration is directly proportional to the number of times or the probability. For example, the greater the number of times or the probability, the longer the duration; or the smaller the number of times or the probability, the shorter the duration. For example, when the number of times or the probability is equal to or exceeds a fifth threshold, the duration is a fifth value (for example, 160 ms); or when the number of times or the probability is equal to or less than a sixth threshold, the duration is a sixth value (for example, 20 ms). In addition, it may be assumed that the duration is inversely proportional to the number of times or the probability. For example, the greater the number of times or the probability, the shorter the duration; or the smaller the number of times or the probability, the longer the duration.

In some embodiments, the target time object may be associated with the number of times and/or a probability that the right to use the channel and/or carrier is not obtained by the terminal within a time period, or the number of times and/or a probability that the channel and/or carrier are/is determined as busy or unavailable, or the number of times and/or a probability that the right to use the synchronization signal block is not obtained, or the number of times and/or a probability that the synchronization signal block candidate resource is determined as busy or unavailable. For example, it may be assumed that the duration is inversely proportional to the number of times or the probability. For example, the greater the number of times or the probability, the shorter the duration; or the smaller the number of times or the probability, the longer the duration. For example, when the number of times or the probability is equal to or exceeds a seventh threshold, the duration is a seventh value (for example, 20 ms); or when the number of times or the probability is equal to or less than an eighth threshold, the duration is an eighth value (for example, 160 ms). In addition, it may be assumed that the duration is directly proportional to the number of times or the probability. For example, the greater the number of times or the probability, the longer the duration; or the smaller the number of times or the probability, the shorter the duration.

Optionally, the channel conditions may be understood as a load degree, an occupancy or busyness degree, signal strength, interference intensity, or the like.

Optionally, the listening mode may include which type of LBT is used by FBE or LBE, such as Cat1 LBT, Cat2 LBT, or Cat4 LBT. For example, it may be assumed that the duration corresponding to the target time object is equal to a length corresponding to a frame period or frame length or time domain structure length (fixed frame period) in FBE mode, or is equal to the length minus an idle period, or is equal to the length minus a length of z CCAs or eCCAs.

Optionally, the channel is in sharing mode, and the sharing mode may include FBE or LBE.

Optionally, an association relationship between the number of beams and the duration of the target time object may meet:
the greater the number of beams, the shorter the duration of the target time object; or the smaller the number of beams, the longer the duration of the target time object; or
the greater the number of beams, the longer the duration of the target time object; or the smaller the number of beams, the shorter the duration of the target time object.

Optionally, an association relationship between the number of resource objects and the duration of the target time object may meet:
the greater the number of resource objects, the shorter the duration of the target time object; or the smaller the number of resource objects, the longer the duration of the target time object; or
the greater the number of resource objects, the longer the duration of the target time object; or the smaller the number of resource objects, the shorter the duration of the target time object.

Optionally, an association relationship between the number of frequency domain positions and frequency domain ranges and the duration of the target time object may meet:
the higher the frequency domain position or range, the shorter the duration of the target time object; or the lower the frequency domain position or range, the longer the duration of the target time object; or
the higher the frequency domain position or range, the longer the duration of the target time object; or the lower the frequency domain position or range, the shorter the duration of the target time object.

Optionally, the SCS may be directly proportional or inversely proportional to the duration corresponding to the target time object.

Optionally, the foregoing L is associated with the number of LBT success times or the LBT success probability of the terminal. It may be understood that the L is associated with the number of LBT success times or the LBT success probability of the terminal within a time period. For example, it may be assumed that the L is directly proportional to the number of success times or the success probability. For example, the greater the number of success times or the success probability, the greater the L; or the smaller the number of success times or the success probability, the smaller the L. For example, in some embodiments, when the number of success times or the success probability is equal to or exceeds a ninth threshold, the L is a ninth value (for example, 1); or when the number of success times or the success probability is equal to or less than a tenth threshold, the L is a tenth value (for example, 16). In addition, it may be assumed that the L is inversely proportional to the number of success times or the success probability. For example, the greater the number of LBT success times or the LBT success probability of the terminal within a time period, the smaller the L; or the smaller the number of success times or the success probability, the greater the L.

Optionally, the L is associated with the number of LBT failure times or the LBT failure probability of the terminal. It may be understood that the L is associated with the number of LBT failure times or the LBT failure probability of the terminal within a time period. For example, it may be assumed that the L is inversely proportional to the number of failure times or the failure probability. For example, the greater the number of failure times or the failure probability, the smaller the L; or the smaller the number of failure times or the failure probability, the greater the L. For example, in some embodiments, when the number of failure times or the failure probability is equal to or exceeds an eleventh threshold, the L is an eleventh value (for example, 16); or when the number of failure times or the failure probability is equal to or less than a twelfth threshold, the L is a twelfth value (for example, 1). In addition, it may be assumed that the L is directly proportional to the number of failure times or the failure probability. For example, the greater the number of LBT failure times or the LBT failure probability of the terminal within a time period, the greater the L; or the smaller the number of failure times or the failure probability, the smaller the L.

In some embodiments, the L may be associated with the number of times and/or the probability that the right to use the channel and/or carrier is obtained by the terminal within a time period, or the number of times and/or the probability that the channel and/or carrier are/is determined as idle or available, or the number of times and/or the probability that the right to use the synchronization signal block is obtained, or the number of times and/or the probability that the synchronization signal block candidate resource is determined as idle or available. For example, it may be assumed that the L is directly proportional to the number of times or the probability. For example, the greater the number of times or the probability, the greater the L; or the smaller the number of times or the probability, the smaller the L. For example, when the number of times or the probability is equal to or exceeds a thirteenth threshold, the L is a thirteenth value (for example, 1); or when the number of times or the probability is equal to or less than a fourteenth threshold, the duration is a fourteenth value (for example, 16). In addition, it may be assumed that the L is inversely proportional to the number of times or the probability. For example, the greater the number of times or the probability that the right to use the channel and/or carrier is obtained by the terminal within a time period, the smaller the L; or the smaller the number of times or the probability, the greater the L.

In some embodiments, the L may be associated with the number of times and/or the probability that the right to use the channel and/or carrier is not obtained by the terminal within a time period, or the number of times and/or the probability that the channel and/or carrier are/is determined as busy or unavailable, or the number of times and/or the probability that the right to use the synchronization signal block is not obtained, or the number of times and/or the probability that the synchronization signal block candidate resource is determined as busy or unavailable. For example, it may be assumed that the L is inversely proportional to the number of times or the probability. For example, the greater the number of times or the probability, the smaller the L; or the smaller the number of times or the probability, the greater the L. For example, when the number of times or the probability is equal to or exceeds a fifteenth threshold, the L is a fifteenth value (for example, 16); or when the number of times or the probability is equal to or less than a sixteenth threshold, the L is a sixteenth value (for example, 1). In addition, it may be assumed that the L is directly proportional to the number of times or the probability. For example, the greater the number of times or the probability, the greater the L; or the smaller the number of times or the probability, the smaller the L.

Optionally, it may be assumed that a value of the L corresponds to a target length in FBE mode, and that the target length is equal to a length corresponding to a frame period or frame length or time domain structure length (fixed frame period), or is equal to the length minus an idle period, or is equal to the length minus a length of z CCAs or eCCAs.

Optionally, the association relationship between the number of beams and L may meet:
the greater the number of beams, the greater the L; the smaller the number of beams, the smaller the L; or
the greater the number of beams, the smaller the L; the smaller the number of beams, the greater the L.

Optionally, an association relationship between the number of resource objects and the duration of the target time object may meet:
the greater the number of resource objects, the greater the L; or the smaller the number of resource objects, the smaller the L; or
the greater the number of resource objects, the smaller the L; or the smaller the number of resource objects, the greater the L.

Optionally, an association relationship between the number of frequency domain positions and frequency domain ranges and the duration of the target time object may meet:
the higher the frequency domain position or range, the greater the L; or the lower the frequency domain position or range, the smaller the L; or
the higher the frequency domain position or range, the smaller the L; or the lower the frequency domain position or range, the greater the L.

Optionally, the SCS may be directly proportional or inversely proportional to a value of L.

Optionally, in some embodiments, the first signal and/or the target time object in which the first signal is located meet/meets one of the following:
being in a resource pool; and
being outside the resource pool.

Further, in some embodiments, the method further includes:
the terminal listens at a preset time or any time.

In this embodiment of this application, that the terminal listens at a preset time or any time may be understood as “the terminal starts listening at the preset time or any time, or the terminal starts LBT at the preset time or any time”.

Optionally, in some embodiments, the terminal starts monitoring the channel from a start point or position of an interval or a position that is preset duration away from a next candidate resource. It should be noted that in this embodiment of this application, the terminal may use the FBE mode to listen to the channel.

Optionally, the preset time is a start time of a target interval, or a time domain interval between the preset time and a next first signal is a second preset value.

Optionally, the target interval is greater than or equal to the second preset value.

Optionally, the target interval includes any one of the following: an interval included in the first signal, an interval included in the resource object, and an interval included in a target time object in which the first signal is located.

Optionally, in some embodiments, the method further includes:
the terminal performs a first operation, where
the first operation includes at least one of the following:
determining that a right to use a first object is obtained;
determining that the first object is available;
determining that the first object is idle; and
transmitting a second signal, where the second signal includes at least one of a synchronization signal block and a preset signal, where
the first object is any one of the following: a channel or carrier in which the first signal is located, a channel or carrier in which the resource object is located, and a channel or carrier in which the target time object is located.

Optionally, a first time at which the terminal performs the first operation meets any one of the following:
the first time is a start time of a target resource object;
the first time is located before the start time of the target resource object, and an interval between the first time and the start time of the target resource object is less than or equal to a third preset value;
the first time is any time;
the first time is located in the target resource object; and
the first time is located before the start time of the target resource object, and the interval between the first time and the start time of the target resource object is greater than or equal to a fourth preset value, where
the target resource object is any one of the N resource objects or a preset resource object.

In this embodiment of this application, in a case that the first time is the start time of the target resource object, or that the first time is located before the start time of the target resource object, and the interval between the first time and the start time of the target resource object is less than or equal to the third preset value, the resource object may be understood as semi-statically fixed, and the terminal needs to attempt to obtain the right to use the channel before the resource object and then immediately transmit the first signal. In this case, transmitting the second signal may be understood as transmitting the second signal by the terminal on a resource object.

In a case that the first time is anytime, the resource object may be understood as flexible, and is determined by a time of successfully accessing the channel. In this case, transmitting the second signal may be understood as starting transmitting the second signal by the terminal from the first time.

When the first time is located in the target resource object, transmitting the second signal may be understood as: transmitting the preset signal by the terminal at the start of the first time and/or before the end of the target resource object and/or at a start point or before the end of a resource object after the target resource object. Further optionally, in a case that at least one resource object exists after the target resource object, a synchronization signal block may be transmitted in at least part of the at least one resource object.

It should be noted that in this embodiment of this application, the number of transmitted synchronization signal blocks may be set based on an actual requirement. For example, in some embodiments, the number of transmitted synchronization signal blocks may be preconfigured, prescribed in a protocol, configured, indicated by another terminal, or determined by the terminal autonomously.

Optionally, in a case that the first time is located before the start time of the target resource object, and the interval between the first time and the start time of the target resource object is greater than or equal to the fourth preset value, transmitting the second signal may be understood as: transmitting the preset signal by the terminal at the start of the first time and/or before the end of the target resource object and/or at a start point or before the end of a resource object after the target resource object. Further optionally, in a case that at least one resource object exists after the target resource object, a synchronization signal block may be transmitted in at least part of the at least one resource object.

Optionally, in some embodiments, that the terminal performs a first operation includes:
in a case that a first preset condition is met, performing the first operation, where
the first preset condition includes at least one of the following: detected power or energy is less than a fifth preset value; and a preset specification is met.

In this embodiment of this application, “detected power or energy is less than a fifth preset value” may be understood as “whether the power or energy less than the fifth preset value and detected in second preset duration exists in first preset duration”. The first preset duration and the second preset duration may be set based on an actual requirement. For example, in some embodiments, the first preset duration is 25 s, and the second preset duration is 16 s, 9 s, or 4 μs. The preset specification may be understood as “the detected power or energy meets a channel or carrier occupancy specification”.

Optionally, in some embodiments, the preset signal is any one of the following:
part of the first signal;
another synchronization signal block different from the synchronization signal block; and
a preamble.

In this embodiment of this application, the synchronization signal block in the first signal may be referred to as a first synchronization signal block, and the other synchronization signal block may be referred to as a second synchronization signal block.

It should be noted that the part of the first signal may be understood as part of the signal in the first synchronization signal block, and the part of the signal may be a PSS and/or an SSS. Optionally, in a case that the first time is located before the start time of the target resource object, and the interval between the first time and the start time of the target resource object is greater than or equal to the fourth preset value, the part of the first signal may be understood as a corresponding first signal part from the first time on the target resource object to the end of the target resource object. The second synchronization signal block may be another synchronization signal block that is a combination of at least two of the SSS, the PSS, and the PSBCH in FDM mode, or another synchronization signal block that is a combination of at least two of the SSS, the PSS, and the PSBCH in TDM mode and that has a structure different from the first synchronization signal block. In other words, there are two types of synchronization signal blocks. For example, after the channel is preempted, if the channel is in a synchronization signal block candidate resource, because a complete first synchronization signal block cannot be sent, a second synchronization signal block is sent. After the channel is preempted, if the channel is at a start point of the synchronization signal block candidate resource, the first synchronization signal block is transmitted.

It should be noted that in this embodiment of this application, assuming that the first preset condition is met at the first time, a transmission behavior of the terminal (for example, a transmission behavior of transmitting at least one of the synchronization signal block and the preset signal) includes the following cases.

Case 1-1: Assuming that the first time is a start point of a synchronization signal block candidate resource, or is before a start point of a synchronization signal block candidate resource and an interval from the start point is not greater than a preset value, the transmission behavior is understood as transmitting (receiving or sending) the synchronization signal block on the synchronization signal block candidate resource by the UE. In this case, the synchronization signal block candidate resource is semi-statically fixed. The UE needs to attempt to obtain the right to use the channel before the candidate resource, and then immediately start transmitting the synchronization signal block.

Case 1-2: Assuming that the first time is any time, that is, the first time is not specified, the transmission behavior may be understood as transmitting the synchronization signal block by the terminal. For example, the synchronization signal block is transmitted starting from the first time. In this case, the synchronization signal block candidate resource is flexible and is determined based on the time of successful access to the channel, rather than being semi-statically fixed.

Case 2: Assuming that the first time is located in a synchronization signal block candidate resource, the transmission behavior may be understood as transmitting the preset signal by the terminal, for example, starting from the first time, and/or before the end of the synchronization signal block candidate resource, and/or at a start point or before the end of a synchronization signal block candidate resource after the synchronization signal block candidate resource.

Further optionally, the synchronization signal block candidate resource is followed by one or more synchronization signal block candidate resources.

Further optionally, the terminal may transmit the synchronization signal block in at least part of the one or more synchronization signal block candidate resources.

Case 3: Assuming that the first time is before a start point of a synchronization signal block candidate resource and an interval from the start point is greater than a preset value, the transmission behavior may be understood as transmitting the preset signal. For example, the terminal transmits the preset signal starting from the first time, and/or in at least part of the interval, and/or at a start point or before the end of the synchronization signal block candidate resource, and/or at a start point or before the end of a synchronization signal block candidate resource after the synchronization signal block candidate resource.

Further optionally, the synchronization signal block candidate resource is followed by one or more synchronization signal block candidate resources.

Further optionally, the terminal may transmit the synchronization signal block in at least part of the one or more synchronization signal block candidate resources.

It should be noted that the synchronization signal block candidate resource in this embodiment of this application may be understood as a candidate resource in the foregoing resource object.

The preset signal may be at least part of the synchronization signal block, that is, the synchronization signal block may also be used to mark one or some SL systems, sidelink interfaces, sidelink services, sidelink groups, or priorities, and may also be used to mark one or some synchronization references and/or spatial references and/or position references and/or beam references and/or quasi-co-location (QCL) references. For example, in some embodiments, the synchronization signal block or the preset signal may identify at least one of the following:
a sidelink terminal, a sidelink system, a sidelink interface, a sidelink service, a priority, synchronization information, spatial information, location information, beam information, quasi-co-location information, transmission configuration indication information, a sidelink group, and an occupancy status of a first object, where
the first object is a channel, a carrier, or a resource.

In this embodiment of this application, identifying a sidelink terminal may be understood as identifying any sidelink terminal or a preset sidelink terminal; identifying a sidelink system may be understood as identifying any sidelink system or a preset sidelink system; identifying a sidelink interface may be understood as identifying any sidelink interface or a preset sidelink interface; identifying a priority may be understood as identifying any priority or a preset priority; identifying synchronization information may be understood as identifying any synchronization information or preset synchronization information; identifying spatial information may be understood as identifying any spatial information or preset spatial information; identifying location information may be understood as identifying any location information or preset location information; identifying beam information may be understood as identifying any beam information or preset beam information; identifying quasi-co-location information may be understood as identifying any quasi-co-location information or preset quasi-co-location information; identifying transmission configuration indication information may be understood as identifying any transmission configuration indication information or preset transmission configuration indication information; identifying a sidelink group may be understood as identifying any sidelink group or a preset sidelink group; and identifying a first object may be understood as identifying any first object or a preset first object.

Optionally, the channel is a channel monitored when the channel is idle or busy. The resource may be understood as a resource block (RB) or a resource block group (RGB).

Optionally, the priority may be understood as an SL priority, a priority of a logical channel (LCH), or a priority of a logical channel group (LCG). The sidelink group may be understood as an SL terminal group or other groups.

Optionally, the synchronization information may include a synchronization reference, the spatial information may include a spatial reference, the location information may include a location reference, the beam information may include a beam reference, the quasi-co-location information may include a quasi-co-location reference, and the transmission configuration indication information may include a transmission configuration indication reference.

Optionally, the sidelink group may be understood as a sidelink terminal group, which may include, for example, terminals corresponding to same or preset target information. The target information includes at least one of the following: a synchronization reference, a spatial reference, a location reference, a beam reference, a QCL reference, a service, a source ID, a destination ID, a packet, a process ID, traffic, a priority, a distance, a range, a session, unicast, and groupcast.

Optionally, in some embodiments, the method further includes:
the terminal performs a second operation, where
the second operation includes at least one of the following:
determining that a right to use a second object is not obtained;
determining that the second object is unavailable;
determining that the second object is busy;
listening to determine the resource object or the target time object; and attempting to obtain a right to use the resource object or the target time object, where
the second object is any one of the following: a channel or carrier in which the first signal is located, a channel or carrier in which the resource object is located, and a channel or carrier in which the target time object is located.

In this embodiment of this application, listening to determine the resource object or the target time object may be understood as listening by the terminal to consider or determine a status of the resource object or the target time object. For example, the terminal may listen to consider or determine that the status of the resource object or the target time object is unavailable, or listen to consider or determine that the resource object or the target time object is occupied.

Attempting to obtain the right to use the resource object or the target time object may be understood as: if the resource object or the target time object is originally configured and/or preconfigured and/or indicated and/or scheduled and/or determined as used for sending, the UE attempts to listen to the channel to determine whether the resource object or the target time object is available or attempts to obtain the right to use the resource object or the target time object.

Further, if the target resource object is available or the right to use the target resource object is obtained, the terminal can send the synchronization signal block on the target resource object.

Optionally, that the terminal performs a second operation includes:
in a case that a second preset condition is met, the terminal performs the second operation, where
the second preset condition includes at least one of the following: detected power or energy is greater than or equal to a fifth preset value; and
a preset specification is not met.

For better understanding this application, details are hereinafter described by using some specific embodiments.

Embodiment 1: Assuming that a terminal detects that a channel meets a condition at a time n, the terminal performs a first behavior.

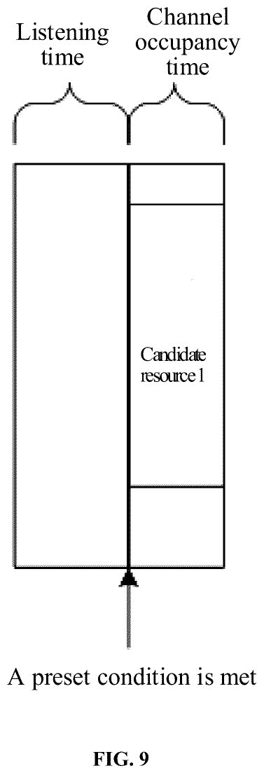

For example, as shown in FIG. 9, if it is detected within a time period that the channel is idle or detected energy or power is less than a preset value, and the time n is a start point of a candidate resource 1, the terminal performs the first behavior.

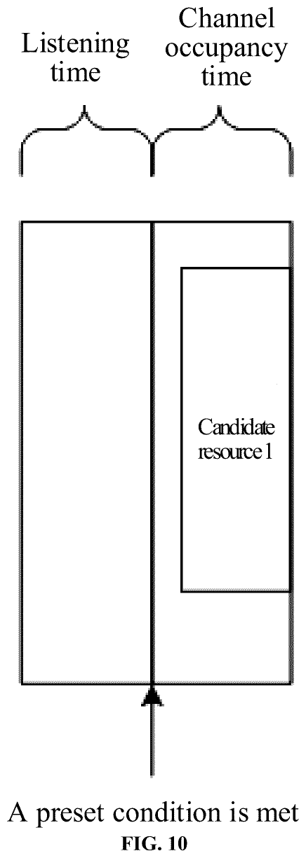

As shown in FIG. 10, if it is detected within a time period that the channel is idle or detected energy or power is less than a preset value, and the time n is before the start point of the candidate resource 1 and an interval between the time n and the start point is less than or equal to a preset value, the terminal performs the first behavior.

The first behavior includes at least one of the following:
the terminal transmits a synchronization signal block on the candidate resource 1; and
the terminal considers that the channel has been obtained, determines that the channel is available, or determines that the channel is idle.

Embodiment 2: Assuming that a terminal detects that a channel meets a condition at a time n, the terminal starts to transmit a synchronization signal block.

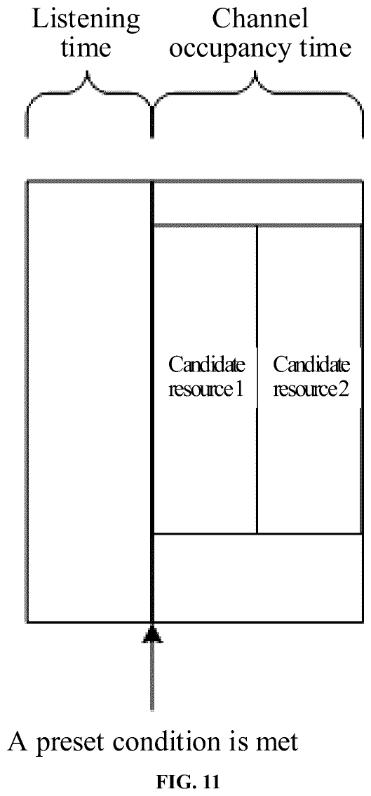

As shown in FIG. 11, for example, if the terminal detects within a time period (such as the time when Cat2 LBT determines that the channel is idle) that the channel is idle or detected energy or power is less than a preset value, the terminal starts to transmit the synchronization signal block.

Embodiment 3: Assuming that a terminal detects that a channel meets a condition at a time n, the terminal performs a second behavior.

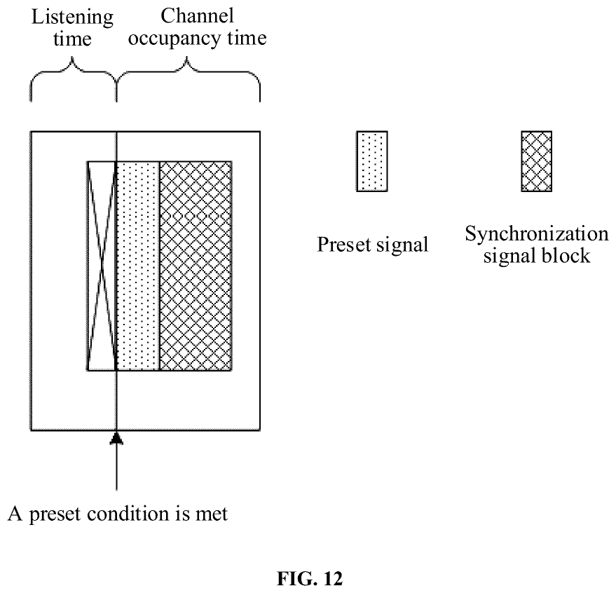

For example, as shown in FIG. 12, if the terminal detects within a time period (such as the time when Cat2 LBT determines that the channel is idle) that the channel is idle or detected energy or power is less than a preset value, and the time n is located before a start point of a candidate resource 1, and an interval between the time n and the start point is greater than a preset value, the second behavior performed by the terminal includes at least one of the following: the terminal transmits a preset signal; for example, the terminal transmits the preset signal starting from the time n, and/or in at least part of the interval, and/or at the start point or before the end of the candidate resource 1; and transmits a synchronization signal block on a candidate resource 2 after the candidate resource 1.

Embodiment 4: Assuming that a terminal detects within a time period that a channel is idle or detected energy or power is less than a preset value, and a time n is located before a start point of a candidate resource 1, and an interval between the time n and the start point is greater than a preset value, a second behavior performed by the terminal includes at least one of the following:
the terminal transmits a preset signal; for example, the terminal transmits the preset signal starting from the time n, and/or in at least part of the interval, and/or at the start point or before the end of the candidate resource 1; and
the terminal transmits a synchronization signal block on a candidate resource 2, or transmit a synchronization signal block on at least one of the candidate resource1 and a candidate resource 2.

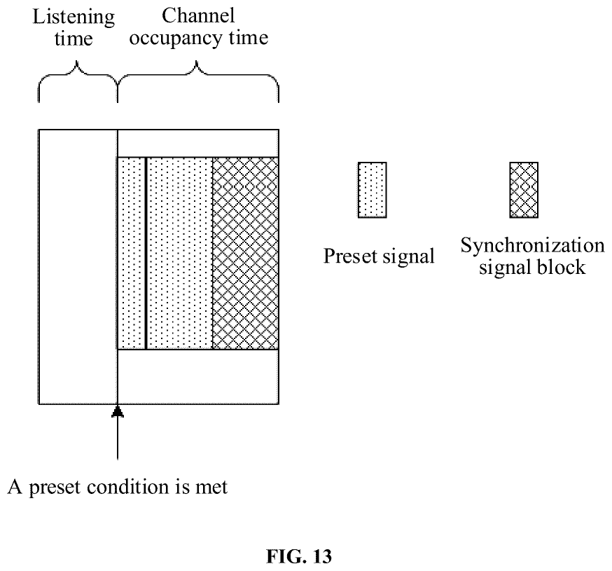

As shown in FIG. 13, the preset signal is transmitted before the end of the candidate resource 1. Further optionally, the synchronization signal block is transmitted on the candidate resource 2 after the candidate resource 1.

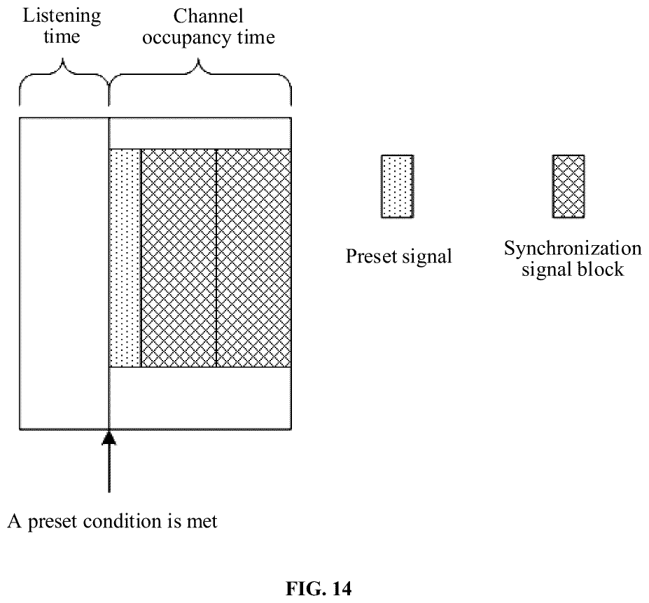

As shown in FIG. 14, the preset signal is transmitted before the start point of the candidate resource 1. Further optionally, the synchronization signal block is transmitted on at least one of the candidate resource 1 and the candidate resource 2.
Embodiment 5: A preset signal may include at least one PSS and/or at least one SSS, where frequency division multiplexing (FDM) is performed on the at least one PSS and the at least one SSS, or time division multiplexing (TDM) is performed on the at least one PSS and the at least one SSS. In addition, FDM may be performed on the at least one PSS and the at least one SSS with a broadcast channel.

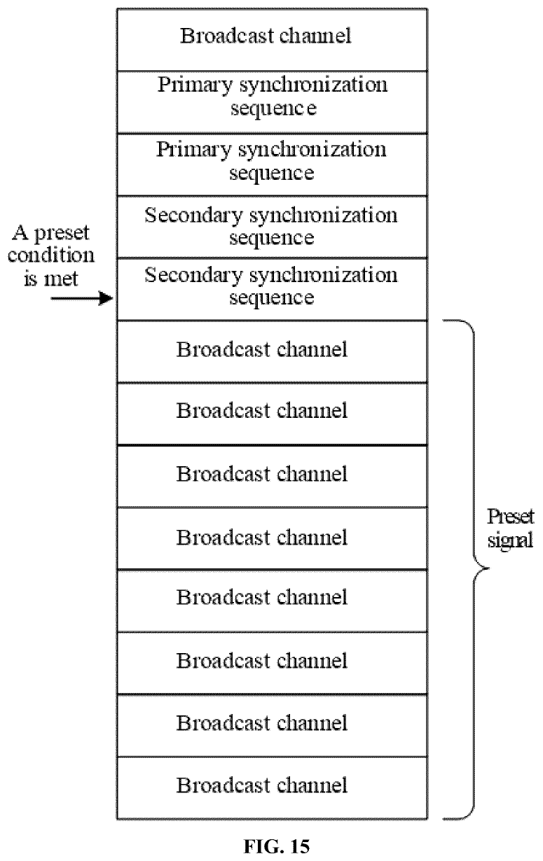

As shown in FIG. 15, in some embodiments, the preset signal is part of a synchronization signal block. For example, it is assumed that the synchronization signal block includes n1 PSSs and n2 SSSs and n3 broadcast channels, where n1, n2, and n3 are natural numbers. UE detects at a time n that a channel meets a preset condition. For example, the UE detects within a time (such as the time when Cat2 LBT determines that the channel is idle) that the channel is idle or detected energy or power is less than a preset value, and the time n is before a second broadcast channel symbol of the synchronization signal block resource, the preset signal is apart from the second broadcast channel symbol to the end of the synchronization signal block.

It should be noted that in this embodiment of this application, a time domain order and a frequency domain order of the PSS and/or the SSS may be set based on an actual situation, and are not further limited herein. FIG. 15 is only an example thereof.

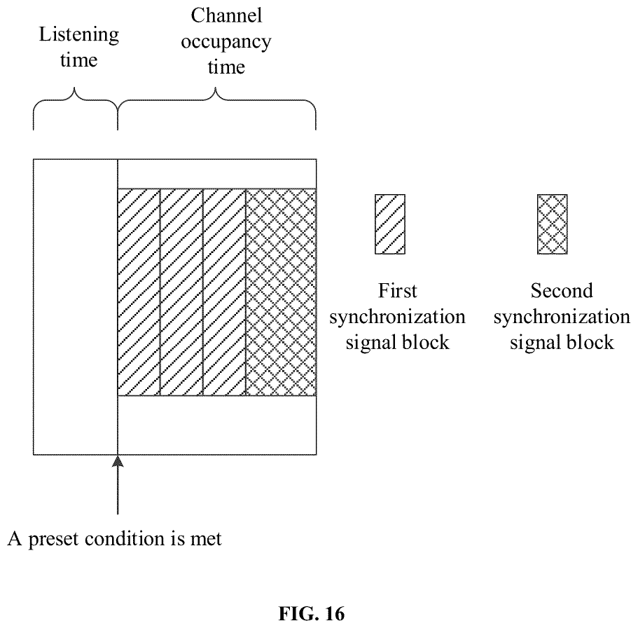

Embodiment 6: Assuming that a terminal detects at a time n that a channel meets a preset condition, for example, the terminal detects within a time (such as the time when Cat2 LBT determines that the channel is idle) that the channel is idle or detected energy or power is less than a preset value, the UE starts to send one or more second synchronization signal blocks at the time n before a synchronization signal block candidate resource. As shown in FIG. 16, an interval exists between the time when the channel is obtained and a candidate resource 1. The UE continuously sends three second synchronization signal blocks within the interval, and then sends a synchronization signal block on the candidate resource 1.

It should be noted that the transmission processing method provided in the embodiments of this application may be performed by a transmission processing apparatus, or a control module for performing the transmission processing method in the transmission processing apparatus. A transmission processing apparatus provided in the embodiments of this application is described by assuming that the transmission processing method in the embodiments of this application is performed by the transmission processing apparatus.

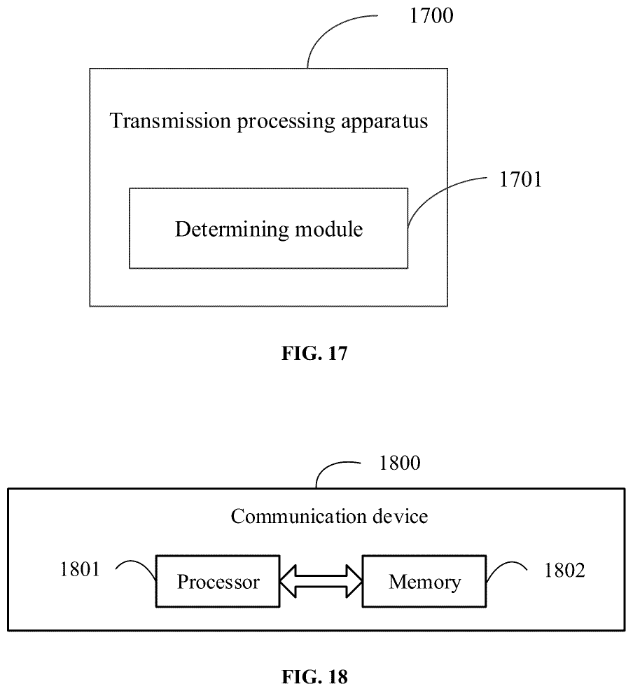

FIG. 17 is a structural diagram of a transmission processing apparatus according to an embodiment of this application. As shown in FIG. 17, the transmission processing apparatus 1700 includes:
a determining module 1701, configured to determine N resource objects used for a first signal, where the first signal includes at least one of a synchronization signal block and a preset signal, where
N is a positive integer, the N resource objects are located within L target time objects, L is a positive integer, the target time object includes a period, a timer, a time window, a transmission cluster, a preset time period, a channel occupancy time, or a time domain unit, and the resource object is a candidate resource or a candidate resource group.

Optionally, the N resource objects meet at least one of the following:
M1 resource objects among the N resource objects are continuous in time domain;
a time domain interval between M2 resource objects among the N resource objects is less than or equal to a first preset value;
a first interval before or after at least part of M3 resource objects is less than or equal to the first preset value, where the M3 resource objects are at least part of the N resource objects;
M4 first signals associated with at least part of the N resource objects are continuous;
a time domain interval between M5 first signals associated with at least part of the N resource objects is less than or equal to the first preset value; and
a second interval before or after at least part of M6 first signals is less than or equal to the first preset value, where the M6 first signals are first signals associated with at least part of the N resource objects, where
all of M1, M2, M3, M4, M5, and M6 are positive integers.

Optionally, first signals associated with the N resource objects meet at least one of the following:
at least part of first signals do not include a third interval;
target time objects in which at least part of first signals are located do not include a fourth interval;
at least part of first signals include a fifth interval, and the fifth interval is less than or equal to a first preset value; and
target time objects in which at least part of first signals are located include a sixth interval, and the sixth interval is less than or equal to the first preset value.

Optionally, the at least part of first signals meet at least one of the following:
the at least part of first signals are first N1−1 first signals, where N1 is the total number of the first signals associated with the N resource objects; and
the target time objects in which the at least part of first signals are located include first L−1 target time objects among the L target time objects.

Optionally, the first preset value is a product of a first threshold and 25 μs, 16 μs, 9 μs, 4 μs, listening duration corresponding to the first signal, listening duration corresponding to the resource object, listening duration corresponding to the target time object, duration required for category 2 listening, duration required for category 4 listening, or duration required for category 1 listening.

Optionally, the N resource objects meet any one of the following:
a time domain interval between M7 resource objects among the N resource objects is greater than or equal to a second preset value;
a seventh interval exists before or after at least part of M8 resource objects, and the seventh interval is greater than or equal to the second preset value, where the M8 resource objects are at least part of the N resource objects;
a time domain interval between M9 first signals in the N resource objects is greater than or equal to the second preset value; and
an eighth interval exists before or after at least part of M10 first signals, and the eighth interval is greater than or equal to the second preset value, where the M10 first signals are first signals associated with at least part of the N resource objects, where
all of M7, M8, M9, and M10 are positive integers.

Optionally, the seventh interval and the eighth interval are used for listening.

Optionally, first signals associated with the N resource objects meet at least one of the following:
at least part of first signals include a ninth interval, and the ninth interval is greater than or equal to a second preset value; and
target time objects in which at least part of first signals are located include a tenth interval, and the tenth interval is greater than or equal to the second preset value.

Optionally, the second preset value is a product of a second threshold and 25 μs, 16 μs, 9 μs, 4 μs, listening duration corresponding to the first signal, listening duration corresponding to the resource object, listening duration corresponding to the target time object, duration required for category 2 listening, duration required for category 4 listening, or duration required for category 1 listening.

Optionally, target information is associated with at least one of the following: the number of listening success times, a listening success probability, the number of listening failure times, a listening failure probability, the number of times that a right to use a channel or carrier is obtained, the number of times that the channel or carrier is determined as idle, the number of times or a probability that a right to use the first signal is obtained, the number of times or a probability that the first signal is determined as idle, the number of times or a probability that a right to use the resource object is obtained, the number of times or a probability that the resource object is determined as idle, the number of times or a probability that the right to use the channel or carrier is not obtained, the number of times or a probability that the channel or carrier is determined as busy, the number of times or a probability that the right to use the first signal is not obtained, the number of times or a probability that the first signal is determined as busy, the number of times or a probability that the right to use the resource object is not obtained, the number of times or a probability that the resource object is determined as busy, channel conditions, a listening mode, a channel or carrier sharing mode, the number of beams, the number of the resource objects, a frequency domain position, a frequency domain range, and a subcarrier spacing, where
the target information includes at least one of the following: duration corresponding to the target time object and L.

Optionally, the transmission processing apparatus 1700 further includes:
a listening module, configured to listen at a preset time or any time.

Optionally, the preset time is a start time of a target interval, or a time domain interval between the preset time and a next first signal is a second preset value.

Optionally, the target interval is greater than or equal to the second preset value.

Optionally, the target interval includes any one of the following: an interval included in the first signal, an interval included in the resource object, and an interval included in a target time object in which the first signal is located.

Optionally, the transmission processing apparatus 1700 further includes:
an execution module, configured to perform a first operation, where
the first operation includes at least one of the following:
determining that a right to use a first object is obtained;
determining that the first object is available;
determining that the first object is idle; and
transmitting a second signal, where the second signal includes at least one of a synchronization signal block and a preset signal, where
the first object is any one of the following: a channel or carrier in which the first signal is located, a channel or carrier in which the resource object is located, and a channel or carrier in which the target time object is located.

Optionally, a first time at which the first operation is performed meets any one of the following:
the first time is a start time of a target resource object;
the first time is located before the start time of the target resource object, and an interval between the first time and the start time of the target resource object is less than or equal to a third preset value;
the first time is any time;
the first time is located in the target resource object; and
the first time is located before the start time of the target resource object, and the interval between the first time and the start time of the target resource object is greater than or equal to a fourth preset value, where
the target resource object is any one of the N resource objects or a preset resource object.

Optionally, the execution module is specifically configured to perform the first operation in a case that a first preset condition is met, where
the first preset condition includes at least one of the following: detected power or energy is less than a fifth preset value; and a preset specification is met.

Optionally, the preset signal is any one of the following:
part of the first signal;
another synchronization signal block different from the synchronization signal block; and
a preamble.

Optionally, the synchronization signal block or the preset signal identifies at least one of the following:
a sidelink terminal, a sidelink system, a sidelink interface, a sidelink service, a priority, synchronization information, spatial information, location information, beam information, quasi-co-location information, transmission configuration indication information, a sidelink group, and an occupancy status of a first object, where
the first object is a channel, a carrier, or a resource.

Optionally, the transmission processing apparatus 1700 further includes:
an execution module, configured to perform a second operation, where
the second operation includes at least one of the following:
determining that a right to use a second object is not obtained;
determining that the second object is unavailable;
determining that the second object is busy;
listening to determine the resource object or the target time object; and
attempting to obtain a right to use the resource object or the target time object, where
the second object is any one of the following: a channel or carrier in which the first signal is located, a channel or carrier in which the resource object is located, and a channel or carrier in which the target time object is located.

Optionally, the execution module is specifically configured to perform the second operation in a case that a second preset condition is met, where
the second preset condition includes at least one of the following: detected power or energy is greater than or equal to a fifth preset value; and a preset specification is not met.

The transmission processing apparatus provided in this embodiment of this application is capable of implementing each process in the method embodiment in FIG. 2. To avoid repetition, details are not described herein again.

The transmission processing apparatus in this embodiment of this application may be an apparatus, or an apparatus or an electronic device with an operating system, or may be a component, an integrated circuit, or a chip in the terminal. The apparatus may be a mobile terminal, or may be a nonmobile terminal. For example, the mobile terminal may include but is not limited to the foregoing illustrated type of the terminal 11. The nonmobile terminal may be a server, a network attached storage (NAS), a personal computer (PC), a television (TV), a teller machine, a self-service machine, or the like. This is not specifically limited in this embodiment of this application.

Optionally, as shown in FIG. 18, an embodiment of this application further provides a communication device 1800, including a processor 1801, a memory 1802, and a program or instructions stored in the memory 1802 and capable of running on the processor 1801. For example, when the program or instructions are executed by the processor 1801, each process of the foregoing embodiment of the transmission processing method is implemented, with the same technical effect achieved. To avoid repetition, details are not described herein again.

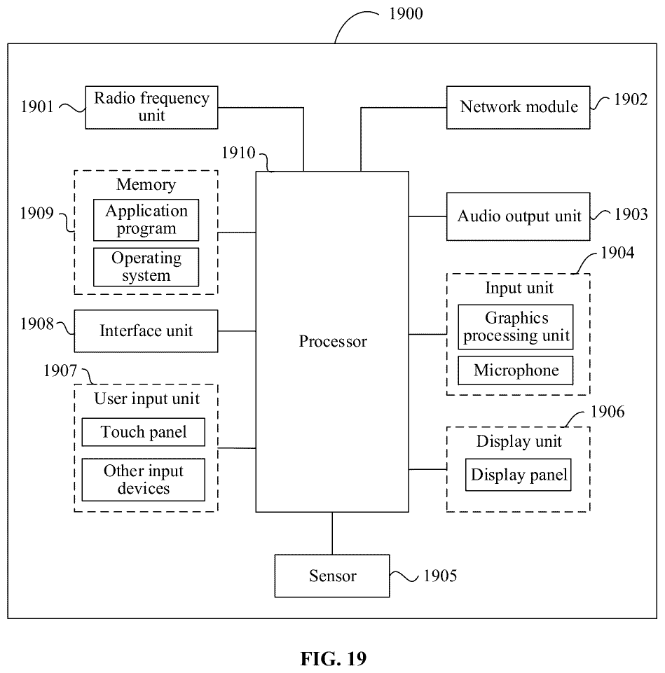

An embodiment of this application further provides a terminal, including a processor and a communication interface. The processor is configured to determine N resource objects used for a first signal, where the first signal includes at least one of a synchronization signal block and a preset signal, where N is a positive integer, the N resource objects are located within L target time objects, L is a positive integer, the target time object includes a period, a timer, a time window, a transmission cluster, a preset time period, a channel occupancy time, or a time domain unit, and the resource object is a candidate resource or a candidate resource group. The terminal embodiment corresponds to the foregoing terminal-side method embodiment, and each implementation process and implementation of the foregoing method embodiment can be applied to the terminal embodiment, with the same technical effect achieved. Specifically, FIG. 19 is a schematic diagram of a hardware structure of a terminal for implementing each embodiment of this application.

The terminal 1900 includes but is not limited to at least some components such as a radio frequency unit 1901, a network module 1902, an audio output unit 1903, an input unit 1904, a sensor 1905, a display unit 1906, a user input unit 1907, an interface unit 1908, a memory 1909, and a processor 1910.

A person skilled in the art may understand that the terminal 1900 may further include a power supply (for example, a battery) supplying power to all components. Optionally, the power supply may be logically connected to the processor 1910 through a power management system. In this way, functions such as charge management, discharge management, and power consumption management are implemented by using the power management system. The terminal structure shown in FIG. 19 does not constitute a limitation on the terminal. The terminal may include more or fewer components than those shown in the figure, or some components are combined, or component arrangements are different. Details are not described herein again.

It should be understood that, in this embodiment of this application, the input unit 1904 may include a graphics processing unit (GPU) and a microphone. The graphics processing unit processes image data of a still picture or video obtained by an image capture apparatus (such as a camera) in a video capture mode or an image capture mode. The display unit 1906 may include a display panel, and the display panel may be configured in a form of a liquid crystal display, an organic light-emitting diode, or the like. The user input unit 1907 includes a touch panel and other input devices. The touch panel is also referred to as a touchscreen. The touch panel may include two parts: a touch detection apparatus and a touch controller. The other input devices may include but are not limited to a physical keyboard, a function button (such as a volume control button or a power button), a trackball, a mouse, and a joystick. Details are not described herein again. In this embodiment of this application, after receiving downlink data from a network-side device, the radio frequency unit 1901 sends the downlink data to the processor 1910 for processing, and in addition, sends uplink data to the network-side device. Generally, the radio frequency unit 1901 includes but is not limited to an antenna, at least one amplifier, a transceiver, a coupler, a low noise amplifier, a duplexer, and the like.

The memory 1909 may be configured to store software programs or instructions and various data. The memory 1909 may primarily include a program or instruction storage area and a data storage area. The program or instruction storage area may store an operating system, an application program or instructions (such as an audio play function and an image play function) required by at least one function, and the like. In addition, the memory 1909 may include a high-speed random access memory, and may further include a non-transitory memory. The non-transitory memory may be a read-only memory (ROM), a programmable read-only memory (PROM), an erasable programmable read-only memory (EPROM), an electrically erasable programmable read-only memory (EEPROM), or a flash memory, for example, at least one disk storage device, a flash memory device, or another non-transitory solid-state storage device.

The processor 1910 may include one or more processing units. Optionally, the processor 1910 may integrate an application processor and a modem processor. The application processor mainly processes the operating system, a user interface, an application program or an instruction, and the like. The modem processor mainly processes wireless communication. For example, the modem processor is a baseband processor. It may be understood that the modem processor may alternatively not be integrated in the processor 1910.

The processor 1910 is configured to determine N resource objects used for a first signal, where the first signal includes at least one of a synchronization signal block and a preset signal, where
N is a positive integer, the N resource objects are located within L target time objects, L is a positive integer, the target time object includes a period, a timer, a time window, a transmission cluster, a preset time period, a channel occupancy time, or a time domain unit, and the resource object is a candidate resource or a candidate resource group.

The terminal provided in this embodiment of this application can implement each process implemented by the method embodiment in FIG. 2, with the same technical effect achieved. To avoid repetition, details are not described herein again.

An embodiment of this application further provides a readable storage medium. The readable storage medium may be volatile or non-volatile. The readable storage medium stores a program or instructions. When the program or instructions are executed by a processor, each process of the foregoing embodiment of the transmission processing method is implemented, with the same technical effect achieved. To avoid repetition, details are not described herein again.

The processor is a processor in the electronic device in the foregoing embodiment. The readable storage medium includes a computer-readable storage medium, for example, a computer read-only memory (ROM), a random access memory (RAM), a magnetic disk, or an optical disc.

In addition, an embodiment of this application provides a chip. The chip includes a processor and a communication interface. The communication interface is coupled to the processor. The processor is configured to run a program or instructions to implement each process of the foregoing embodiment of the transmission processing method, with the same technical effect achieved. To avoid repetition, details are not described herein again.

It should be understood that the chip provided in this embodiment of this application may also be referred to as a system-level chip, a system chip, a chip system, a system-on-chip, or the like.

In addition, an embodiment of this application provides a program product. The program product is stored in a non-transitory storage medium, and the program product is executed by at least one processor to implement each process of the foregoing embodiment of the transmission processing method, with the same technical effect achieved. To avoid repetition, details are not described herein again.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude existence of other identical elements in the process, method, article, or apparatus that includes the element. In addition, it should be noted that the scope of the method and apparatus in the implementations of this application is not limited to performing the functions in an order shown or discussed, and may further include performing the functions in a substantially simultaneous manner or in a reverse order depending on the functions used. For example, the method described may be performed in an order different from that described, and various steps may be added, omitted, or combined. In addition, features described with reference to some examples may be combined in other examples.

According to the foregoing description of the implementations, a person skilled in the art may clearly understand that the methods in the foregoing embodiments may be implemented by using software in combination with a necessary general hardware platform, and certainly may alternatively be implemented by using hardware. However, in most cases, the former is a preferred implementation. Based on such an understanding, the technical solutions of this application essentially or the part contributing to the related art may be implemented in a form of a computer software product. The computer software product is stored in a storage medium (such as a ROM/RAM, a magnetic disk, or an optical disc), and includes several instructions for instructing a terminal (which may be a mobile phone, a computer, a server, an air conditioner, a base station, or the like) to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. Inspired by this application, a person of ordinary skill in the art may develop many other manners without departing from principles of this application and the protection scope of the claims, and all such manners fall within the protection scope of this application.

What is claimed is:

1. A transmission processing method, comprising:
determining, by a terminal, N resource objects used for a synchronization signal block, wherein
N is a positive integer, the N resource objects are located within L periods, L is a positive integer, the resource object is a candidate resource or a candidate resource group, a time domain interval between M2 resource objects among the N resource objects is equal to a first preset value, and a time domain interval between M7 resource objects among the N resource objects is equal to a second preset value, wherein M2 and M7 are positive integers.

2. The method according to claim 1, wherein the N resource objects further meet at least one of the following:
M1 resource objects among the N resource objects are continuous in time domain;
a first interval before or after at least part of M3 resource objects is less than or equal to the first preset value, wherein the M3 resource objects are at least part of the N resource objects;
M4 first signals associated with at least part of the N resource objects are continuous;
a time domain interval between M5 first signals associated with at least part of the N resource objects is less than or equal to the first preset value; or
a second interval before or after at least part of M6 first signals is less than or equal to the first preset value, wherein the M6 first signals are first signals associated with at least part of the N resource objects, wherein
all of M1, M3, M4, M5, and M6 are positive integers.

3. The method according to claim 1, wherein first signals associated with the N resource objects meet at least one of the following:
at least part of first signals do not comprise a third interval;
target time objects in which at least part of first signals are located do not comprise a fourth interval;
at least part of first signals comprise a fifth interval, and the fifth interval is less than or equal to a first preset value; or
target time objects in which at least part of first signals are located comprise a sixth interval, and the sixth interval is less than or equal to the first preset value.

4. The method according to claim 3, wherein the at least part of first signals meet at least one of the following:
the at least part of first signals are first N1−1 first signals, wherein N1 is the total number of the first signals associated with the N resource objects; or
the target time objects in which the at least part of first signals are located comprise first L−1 target time objects among the L target time objects.

5. The method according to claim 2, wherein the first preset value is a product of a first threshold and 25 μs, 16 μs, 9 μs, 4 μs, listening duration corresponding to the first signal, listening duration corresponding to the resource object, listening duration corresponding to the target time object, duration required for category 2 listening, duration required for category 4 listening, or duration required for category 1 listening.

6. The method according to claim 1, wherein the N resource objects further meet any one of the following:
a seventh interval exists before or after at least part of M8 resource objects, and the seventh interval is greater than or equal to the second preset value, wherein the M8 resource objects are at least part of the N resource objects;
a time domain interval between M9 first signals in the N resource objects is greater than or equal to the second preset value; or
an eighth interval exists before or after at least part of M10 first signals, and the eighth interval is greater than or equal to the second preset value, wherein the M10 first signals are first signals associated with at least part of the N resource objects, wherein
all of M8, M9, and M10 are positive integers.

7. The method according to claim 6, wherein the seventh interval and the eighth interval are used for listening.

8. The method according to claim 1, wherein first signals associated with the N resource objects meet at least one of the following:
at least part of first signals comprise a ninth interval, and the ninth interval is greater than or equal to a second preset value; or
target time objects in which at least part of first signals are located comprise a tenth interval, and the tenth interval is greater than or equal to the second preset value.

9. The method according to claim 6, wherein the second preset value is a product of a second threshold and 25 μs, 16 μs, 9 μs, 4 μs, listening duration corresponding to the first signal, listening duration corresponding to the resource object, listening duration corresponding to the target time object, duration required for category 2 listening, duration required for category 4 listening, or duration required for category 1 listening.

10. The method according to claim 1, wherein target information is associated with at least one of the following:
the number of listening success times,
a listening success probability,
the number of listening failure times,
a listening failure probability,
the number of times that a right to use a channel or carrier is obtained,
the number of times that the channel or carrier is determined as idle,
the number of times or a probability that a right to use the first signal is obtained,
the number of times or a probability that the first signal is determined as idle,
the number of times or a probability that a right to use the resource object is obtained,
the number of times or a probability that the resource object is determined as idle,
the number of times or a probability that the right to use the channel or carrier is not obtained,
the number of times or a probability that the channel or carrier is determined as busy,
the number of times or a probability that the right to use the first signal is not obtained,
the number of times or a probability that the first signal is determined as busy,
the number of times or a probability that the right to use the resource object is not obtained,
the number of times or a probability that the resource object is determined as busy,
channel conditions,
a listening mode,
a channel or carrier sharing mode,
the number of beams,
the number of the resource objects,
a frequency domain position,
a frequency domain range, or
a subcarrier spacing, wherein
the target information comprises at least one of the following: duration corresponding to the target time object and L.

11. The method according to claim 1, wherein the method further comprises:
listening, by the terminal, at a preset time or any time, wherein
the preset time is a start time of a target interval, or a time domain interval between the preset time and a next first signal is a second preset value.

12. The method according to claim 11, wherein the target interval is greater than or equal to the second preset value;
or,
wherein the target interval comprises any one of the following: an interval comprised in the first signal, an interval comprised in the resource object, or an interval comprised in a target time object in which the first signal is located.

13. The method according to claim 1, wherein the method further comprises:
performing, by the terminal, a first operation, wherein
the first operation comprises at least one of the following:
determining that a right to use a first object is obtained;
determining that the first object is available;
determining that the first object is idle; or
transmitting a second signal, wherein the second signal comprises at least one of a synchronization signal block or a preset signal, wherein
the first object is any one of the following: a channel or carrier in which the first signal is located, a channel or carrier in which the resource object is located, or a channel or carrier in which the target time object is located.

14. The method according to claim 13,
wherein a first time at which the terminal performs the first operation meets any one of the following:
the first time is a start time of a target resource object;
the first time is located before the start time of the target resource object, and an interval between the first time and the start time of the target resource object is less than or equal to a third preset value;
the first time is any time;
the first time is located in the target resource object; or
the first time is located before the start time of the target resource object, and the interval between the first time and the start time of the target resource object is greater than or equal to a fourth preset value, wherein
the target resource object is any one of the N resource objects or a preset resource object;
or,
wherein the performing, by the terminal, a first operation comprises:
in a case that a first preset condition is met, performing the first operation, wherein
the first preset condition comprises at least one of the following: detected power or energy is less than a fifth preset value; or a preset specification is met.

15. The method according to claim 1,
wherein the preset signal is any one of the following:
part of the first signal;
another synchronization signal block different from the synchronization signal block; or
a preamble;
or,
wherein the synchronization signal block or the preset signal identifies at least one of the following:
a sidelink terminal, a sidelink system, a sidelink interface, a sidelink service, a priority, synchronization information, spatial information, location information, beam information, quasi-co-location information, transmission configuration indication information, a sidelink group, or an occupancy status of a first object, wherein
the first object is a channel, a carrier, or a resource.

16. The method according to claim 1, wherein the method further comprises:
performing, by the terminal, a second operation, wherein
the second operation comprises at least one of the following:
determining that a right to use a second object is not obtained;
determining that the second object is unavailable;
determining that the second object is busy;
listening to determine the resource object or the target time object; or
attempting to obtain a right to use the resource object or the target time object, wherein
the second object is any one of the following: a channel or carrier in which the first signal is located, a channel or carrier in which the resource object is located, or a channel or carrier in which the target time object is located;
wherein the performing, by the terminal, a second operation comprises:
in a case that a second preset condition is met, performing, by the terminal, the second operation, wherein
the second preset condition comprises at least one of the following: detected power or energy is greater than or equal to a fifth preset value; or a preset specification is not met.

17. A terminal, comprising a memory, a processor, and a program stored in the memory and capable of running on the processor, wherein the program, when executed by the processor, causes the terminal to perform:
determining N resource objects used for a synchronization signal block, wherein
N is a positive integer, the N resource objects are located within L periods, L is a positive integer, the resource object is a candidate resource or a candidate resource group, a time domain interval between M2 resource objects among the N resource objects is equal to a first preset value, and a time domain interval between M7 resource objects among the N resource objects is equal to a second preset value, wherein M2 and M7 are positive integers.

18. The terminal according to claim 17, wherein the N resource objects further meet at least one of the following:
M1 resource objects among the N resource objects are continuous in time domain;
a first interval before or after at least part of M3 resource objects is less than or equal to the first preset value, wherein the M3 resource objects are at least part of the N resource objects;
M4 first signals associated with at least part of the N resource objects are continuous;
a time domain interval between M5 first signals associated with at least part of the N resource objects is less than or equal to the first preset value; or
a second interval before or after at least part of M6 first signals is less than or equal to the first preset value, wherein the M6 first signals are first signals associated with at least part of the N resource objects, wherein
all of M1, M3, M4, M5, and M6 are positive integers.

19. The terminal according to claim 17, wherein first signals associated with the N resource objects meet at least one of the following:
at least part of first signals do not comprise a third interval;
target time objects in which at least part of first signals are located do not comprise a fourth interval;
at least part of first signals comprise a fifth interval, and the fifth interval is less than or equal to a first preset value; or
target time objects in which at least part of first signals are located comprise a sixth interval, and the sixth interval is less than or equal to the first preset value;
wherein the at least part of first signals meet at least one of the following:
the at least part of first signals are first N1−1 first signals, wherein N1 is the total number of the first signals associated with the N resource objects; or
the target time objects in which the at least part of first signals are located comprise first L−1 target time objects among the L target time objects.

20. A non-transitory readable storage medium, wherein the non-transitory readable storage medium stores a program or instructions, wherein the program or instructions, when executed by a processor of a terminal, causes the processor of the terminal to perform:
determining N resource objects used for a synchronization signal block, wherein
N is a positive integer, the N resource objects are located within L periods, L is a positive integer, the resource object is a candidate resource or a candidate resource group, a time domain interval between M2 resource objects among the N resource objects is equal to a first preset value, and a time domain interval between M7 resource objects among the N resource objects is equal to a second preset value, wherein M2 and M7 are positive integers.
